(19) United States
(12) Patent Application Publication
(10) Pub. No.: US 2025/0298632 A1
(43) Pub. Date: Sep. 25, 2025

(54) GRAPHICAL REMOTE MODIFICATION OF A CONFIGURATION FILE DEFINING A COMPUTING ENVIRONMENT CONFIGURATION

(71) Applicant: Palantir Technologies Inc., Denver, CO (US)

(72) Inventors: Frauke Hein, London (GB); Akshay Agrawal, Jersey City, NJ (US); Christopher Jeganathan, London (GB); Ndeye Fatou Diop, Asnières-sur-Seine (FR); Joseph Hashim, London (GB)

(21) Appl. No.: 18/940,553

(22) Filed: Nov. 7, 2024

Related U.S. Application Data
(60) Provisional application No. 63/568,721, filed on Mar. 22, 2024.

(51) Int. Cl. G06F 9/445

(52) U.S. Cl. CPC G06F 9/44505

(57) ABSTRACT

Computer-implemented systems and methods are disclosed, including for remotely modifying a configuration file defining a computing environment configuration. A computer-implemented may include, for example, receiving, from a remote server computing device, a configuration file defining a computing environment configuration, parsing the configuration file to generate an indexed data structure, the indexed data structure comprising location identifiers of characters of the configuration file, storing the indexed data structure, generating a graphical user interface based at least in part on the indexed data structure, receiving, via the graphical user interface, a user input indicating a modification to the computing environment configuration, determining, by reference to the indexed data structure and the location identifiers, and based on the user input, one or more changes to the configuration file, and communicating, to the remote server computing device, instructions to update the configuration file in accordance with the one or more changes.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for initializing and altering computing environment configurations. More specifically, the present disclosure relates to systems and frameworks for authoring and editing configuration files used in initializing and altering computing environment configurations.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computing environments can be utilized to perform various tasks in computing. Configuration files can be used to initialize or alter a computing environments. Various techniques have been developed to aid in authoring configuration files.

### SUMMARY

The systems, methods, and devices described herein each have several aspects, no single one of which is solely responsible for its desirable attributes. Without limiting the scope of this disclosure, several non-limiting features will now be described briefly.

Computing environments, such as software development environments (e.g., integrated development environments (“IDEs”), web based IDEs, and/or other development environments), other software applications, server processes, operating systems, repositories, and the like, can be important tools for individuals and businesses. In some instances, a user and/or developer of a computing environment can face challenges when initializing and/or using the computing environment. For example, the user may be new and/or unfamiliar with a computing environment. As further examples, a computing environment may be subject to rules specific to the computing environment, restrict a user from installing some development tools, and/or may be an otherwise sensitive environment. In each of these, and other, examples, the user can face a significant burden when using the computing environment, such as when using software development environment to create and/or edit computer code.

The present disclosure includes systems, methods, and software (among other disclosed features) for providing a graphical user interface (“GUI”) based tool (generally referred to herein as “the system”) for creating and editing computing environments. In various implementations, the system may be used to initialize and edit configuration files usable to configure various types of computing environments. A computing environment can be any computing system and/or environment, and can comprise a store of resources, such as computer code, parameters, data, functions, transforms and/or the like. Examples of computing environments can include, but are not limited to software applications, such a development environments used to create and edit computer code and other software application, servers and/or server process, operating systems, and repositories, to list a few.

The system of the present disclosure provides tools for editing a configuration file that is stored on a remote server computing device. As will be described in more detail below, a remote server computing device can be a computing device, in communication with one or more user computing devices, that can store configuration files, execute and/or store a computing environment, host one or more user devices, and/or perform other operations. The server computing device can initialize a computing environment and allow the user devices to access and/or utilize the computing environment.

In various implementations, to edit the configuration file, a user device receives the configuration file that defines the computing environment from the remote server computing device. Once the user device receives the configuration file, the user device can parse the configuration file to generate an indexed data structure. The indexed data structure can include location identifiers for each character of the configuration file. In various implementations, the user device may store the indexed data structure and generate a GUI based at least in part on the indexed data structure and/or other information. For example, the user device may utilize the indexed data structure to generate one or more input selections. The user device may receive a user input, via the GUI, indicating modifications of the computing environment configuration.

The user device can determine, by referencing the indexed data structure and the location identifiers, one or more changes to the configuration file based on the user input. For example, based on user input of input selections, the user device can determine portions or features of the configuration file associated with the modifications to the computing environment configuration indicated by the user input. Each of the one or more changes can be communicated to the remoter server computing device as instructions. The instructions can include the necessary information for the remote server computing device to update the configuration file. For example, the instructions can include modification location identifiers and editing instructions that define the changes, such as deleting and/or inserting characters at the modification location identifiers.

The system can advantageously enable the editing of configuration files using remote communication and using GUIs that can be generated by parsing and indexing the configuration files. The system can advantageously allow the communication of configuration files to user devices and for the user devices to parse the configuration files, generating indexed data structures with location identifiers of the characters of the configuration files. The user devices may advantageously utilize the indexed data structures to generate GUIs and to generate instructions to edit the configuration files from input received via the GUI. The instructions can advantageously be communicated by the user devices to alter the remotely stored configuration files. The system can further advantageously allow for configuration files stored remotely, such as on a remote server computing device, to be accessed and/or edited by one or more user devices while maintaining version control on the configuration files.

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise one or more computer-readable storage mediums having program instructions embodied therewith, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums are disclosed, wherein the computer-readable storage mediums have program instructions embodied therewith, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a schematic block diagram of an example a remote server computing device in an example computing environment, according to various implementations;

FIG. 2 is a flow chart depicting an example process for editing a configuration file stored on a remote server computing device using a user device environment, according to various implementations;

FIG. 3 is a flow chart depicting an example process for updating a configuration file using a remote server computing device environment, according to various implementations;

FIG. 4 is a flow chart depicting an example process for initializing a configuration file stored on a remote server computing device using a user device environment, according to various implementations;

FIGS. 5A-5C are example graphical user interfaces as provided by a user device environment, according to various implementations;

FIG. 6 is an example graphical user interface as provided by a user device environment, according to various implementations;

FIG. 7 illustrates an example indexed data structure, according to various implementations; and

FIG. 8 is a block diagram of an example computer system consistent with various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### I. Overview

Computing environments, such as software development environments (e.g., integrated development environments (“IDEs”), web based IDEs, and/or other development environments), other software applications, server processes, operating systems, repositories, and the like can be important tools for individuals and businesses. In some instances, a user and/or developer of a computing environment can face challenges when initializing and/or using the computing environment. For example, the user may be new and/or unfamiliar with a computing environment. As further examples, a computing environment may be subject to rules specific to the computing environment, restrict a user from installing some development tools, and/or may be an otherwise sensitive environment. In each of these, and other, examples, the user can face a significant burden when using the computing environment, such as when using software development environment to create and/or edit computer code.

The present disclosure describes systems, methods, and software (among other disclosed features) for providing a graphical user interface (“GUI”) based tool (generally referred to herein as “the system”) for creating and editing computing environments. In various implementations, the system may be used to initialize and edit configuration files usable to configure various types of computing environments. A computing environment can be any computing system and/or environment, and can comprise a store of resources, such as computer code, parameters, data, functions, transforms and/or the like. Examples of computing environments can include, but are not limited to software applications, such a development environments used to create and edit computer code and other software application, servers and/or server process, operating systems, and repositories, to list a few.

In some implementations, a computing environment may be stored centrally, relative to multiple users, allowing each user to access the common resources. For example, in some implementations, the users may access the common resources for a shared project. A configuration file, as used in the present disclosure, can be files of computer code, text, and/or characters used to initialize and/or edit a computing environment configuration. For example, the configuration file can be executed to initialize and/or edit the computer code, parameters, data, functions, transforms and/or the like of the computing environment.

The system can advantageously enable the editing of configuration files using remote communication and using GUIs that can be generated by parsing and indexing the configuration files. The system can advantageously allow the communication of configuration files to user devices and for the user devices to parse the configuration files, generating indexed data structures with location identifiers of the characters of the configuration files. The user devices may advantageously utilize the indexed data structures to generate GUIs and to generate instructions to edit the configuration files from input received via the GUI. The instructions can advantageously be communicated by the user devices to alter the remotely stored configuration files. The system can further advantageously allow for configuration files stored remotely, such as on a remote server computing device, to be accessed and/or edited by one or more user devices while maintaining version control on the configuration files.

### Example Aspects Related to Initializing a Computing Environment

Authoring and/or editing a configuration file for a computing environment (for example, a software development environment) can be challenging. As discussed above, one software development environment may have unique rules, restrictions, formats, sensitivities, and/or other attributes that can alter how a configuration file must be authored in that particular software development environment (or other computing environment). As such, software developers can spend significant time searching documentations and/or other information sources to identify syntax requirements, available functions, data resources, naming conventions, and/or other attributes for generating or editing a configuration file for a computing environment (e.g., a software development environment).

The system of the present disclosure provides a GUI based tool users, such as software developers, can utilize to generate and/or edit configuration files. In various implementations, the system can provide input selections on the GUI that can be selected and/or edited. The input selections can be used to generate and/or edit the configuration file. The input selections can include, but are not limited to, selectable lists, textual input fields, checkboxes, and/or the like. In various implementations, the input selections can be used to select and/or edit a type of the computing environment, one or more coding languages for the computing environment (e.g., Python, JavaScript, R, and/or the like), a coding language for the runtime type, libraries, transforms (e.g., containerized transforms), deployed applications, data transformations, inputs and outputs, templates, and/or other aspects of the configuration file.

In various implementations, before a computing environment has been initialized, the input selections may be referred to as setup input selections. The setup input selections may be the same or different than the input selections used to edit a configuration file that has already initialized a computing environment. For example, some setup input selections that were available to the user when creating a configuration file to initialize the computing environment may be unavailable as input selections to edit the configuration file later. Further, new input selections may become available to edit the configuration file after the computing environment has been initialized, such as, for example, when new resources become available after the computing environment has been initialized.

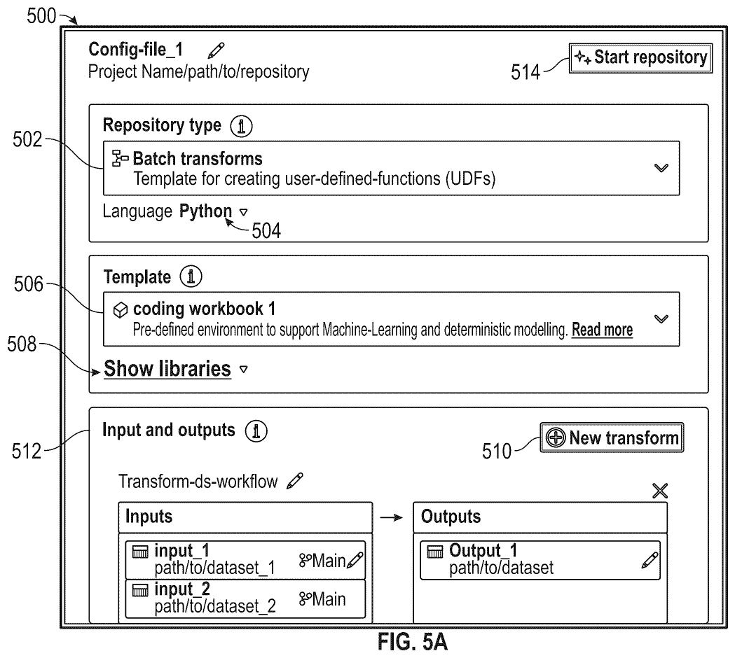

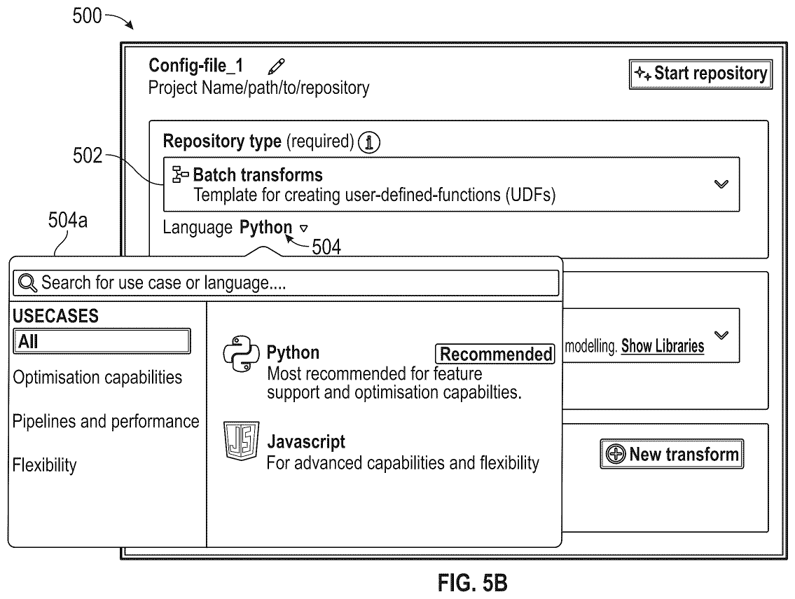

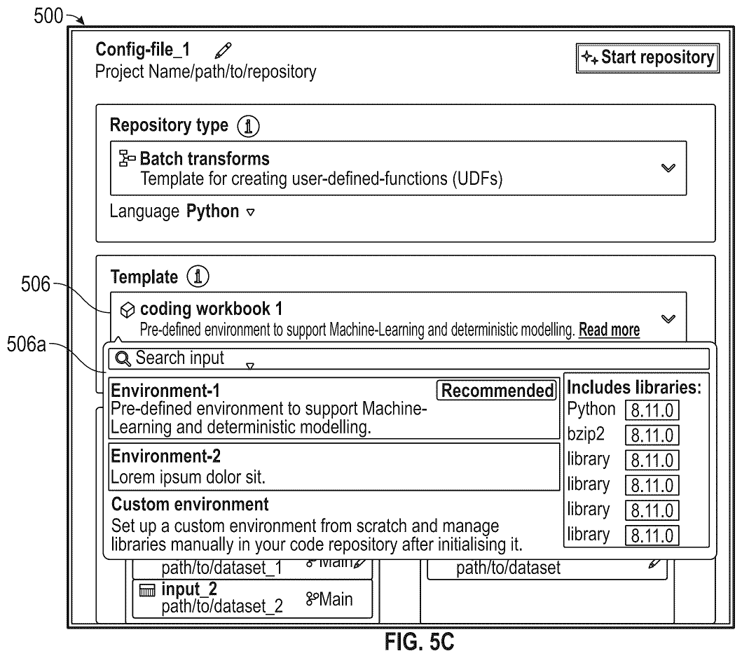

In some implementations, the input selections available, as setup input selections or otherwise, may be determined based on the selection of a previous input selection. For instance, the system may utilize the selection of a type of computing environment, a selected coding language of the computing environment, and/or another input selection to determine one or more additional input selections. As an example, if the computing environment type is selected as a transform (as illustrated in FIGS. 5A-5C), then the system may determine which input and output input selections are needed to complete the configuration file. However, if the computing environment type is selected as a deployed application, then the system may determine different input selections, such as file paths for the deployment, files to be deployed, and/or the like.

In various implementations, each input selection may be associated with one or more parameters. The parameters can provide the appropriate entries for the input selection for a given type of computing environment. For example, for an input selection associated with the coding language, the parameters may provide appropriate languages for the computing environment given the type of the computing environment. In this example, each of the appropriate languages can be presented to a user so the user can select a language for the computing environment. Advantageously, in some implementations, the parameters can ensure the user is presented with entries for an input selection that will work in the computing environment, potentially saving the user time to look up syntax requirements, available functions, data resources, naming conventions, or the like.

In some implementations, the parameters for one input selection may be determined in part based on the selection of one or more previous input selections. For instance, the parameters that define the available values for input and output input selections may be determined in part based on the selection of a coding language, one or more libraries, templates, and/or other selected input selections. As such, only relevant information is associated with each input selection, potentially preventing errors in the configuration file. In some implementations, the system may determine the parameters for an input selection based on other factors, such as, for example, security protocols and permissions associated with the user, security protocols and permissions associated with the computing environment, or security protocols and permissions other sources.

In various implementations, the system can store, track, update, and/or perform other operations such that the appropriate parameters are provided for each input selection. For example, the system can link parameters to rules, conditions, and/or the like, such as rules associated with a computing environment being initialized or edited. As another example, the system can link parameters to another parameter, such as a parameter that is selected at a different input selection. The system can also link parameters to security permissions, and/or any other condition that can help determine if a parameter is appropriate for an input selection.

In various implementations, at least a portion of the parameters are associated with the rules of a particular computing environment. For example, the parameters may be defined by the syntax requirements or available functions of a computing environment. In various implementations, at least a portion of the parameters may be received by the system from one or more sources outside the system. In these implementations, the system may track information associated with receiving the parameters, such as source identifiers, querying protocols, and/or other information needed to receive the parameters.

In some implementations, all, or a portion of the configuration file, input selections, and/or parameters may be determined in part using one or more models, such as large language models (“LLMs”). For example, a user may provide a set of inputs, such as a portion of the input selections, to a LLM and prompt the LLM to create the configuration file, edit the configuration file, to provide input selections and/or to provide parameters for the input selections, to list a few.

In various implementations, the system can initialize a computing environment by communicating one or more parameters to a user device and receiving initialization instructions from the user device with information to generate a configuration file for the computing environment. In these implementations, the user device may generate the initialization instructions based on one or more user inputs. In some implementations, more than one interaction may occur between the user device and the system. For example, the system may send a first set of parameters, receive a set of input selection values from the user device, and send another set of parameters.

In various implementations, the system can initialize a computing environment by communication one or more parameters to a user device an receive a configuration file for the computing environment from the user device. In these implementations, the user device may generate the configuration file based on one or more user inputs.

The user device may generate and/or receive from the system, a GUI based on the parameters. The GUI can include one or more input selections. In some implementations, the GUI may be updated as the user device received one or more inputs from a user. For example, based on a first user input, the user device may generate and/or receive from the system, additional input selections to display on the GUI.

In some implementations, the user device may receive user inputs associated with each of the input selections. In some implementations, the user device may compile each user input, determine the initialization instructions, and communicate the initialization instructions to the system. In other implementations, the user device may communicate each user input as it is received to the system and the system can determine the initialization instruction. The initialization instructions can include a version of a configuration file and/or instructions to create the configuration file, including necessary information for the remote server computing device initialize the configuration file. For example, the initialization instructions can include information such as computing environment types, languages, templates, inputs, outputs, or other information used by the configuration file.

### Example Aspects Related to Editing a Configuration File

In various implementations, a user, such as a software developer, may wish to edit the configuration file to redefine or otherwise alter the computing environment. In addition to the challenges described above, such as the challenges associated with computing environments, editing the configuration file presents further challenges. One such challenge is version control. Once a computing environment has been initialized, it may be utilized by multiple users, such as by multiple users, functions, other computing environments, and/or the like. In some instances, it may be desirable or necessary for all users to access the same version of the computing environment, use the same version of the computing environment and/or track the current version of the computing environment. As such, one aspect of the challenge of version control is ensuring consistency of the configuration file for each user. Another aspect of the challenge of version control is tracking changes within the configuration file. In some instances, it may be desirable to track changes for each character of the configuration file as the changes occur. Further, it may be desirable for the system to only change characters of the configuration file that are necessary for each change, leaving the other characters of the configuration file unaltered.

The system of the present disclosure provides tools for editing a configuration file that is stored on a remote server computing device. As will be described in more detail below, a remote server computing device can be a computing device, in communication with one or more user computing devices, that can store configuration files, execute and/or store a computing environment, host one or more user devices, and/or perform other operations. The server computing device can initialize a computing environment and allow the user devices to access and/or utilize the computing environment.

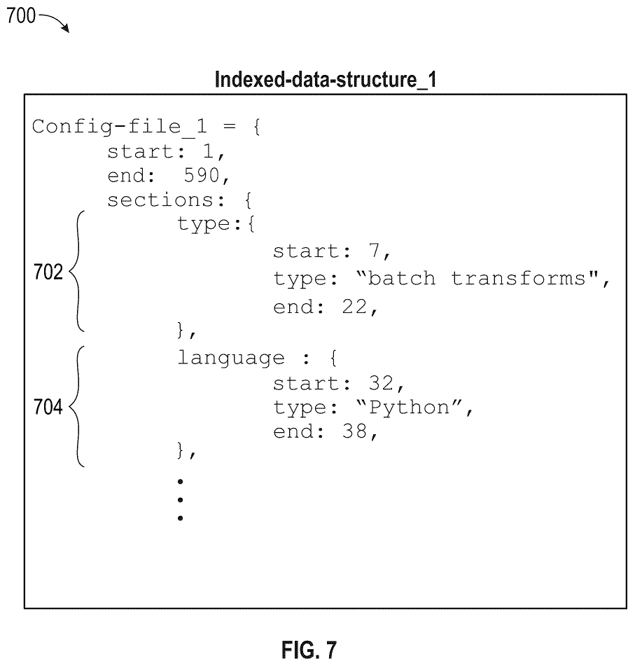

In various implementations, to edit the configuration file, a user device receives the configuration file that defines the computing environment from the remote server computing device. The user device may send a request to edit the configuration file to the remote server computing device and/or access the configuration file on the remote server computing device. Once the user device receives the configuration file, the user device can parse the configuration file to generate an indexed data structure. The indexed data structure can include location identifiers for each character of the configuration file. The characters can include string based characters, return characters, syntax identifiers (e.g., indentation and/or other syntax indicators), and/or other characters of the configuration file. The indexed data structure can comprise a linear data structure, an array, a linked list, a stack, a queue, a tree, a graph, and/or any other data structure that can be used to store an association of each character to a location within the configuration file. In some implementations, the indexed data structure can include textual representations of portions or features of the configuration file and starting and ending character locations of the portions or features. One example of an indexed data structure is illustrated and described in reference to FIG. 7.

In various implementations, the user device may store the indexed data structure. For example, the user device may store the indexed data structure locally on the user device and/or remotely, such as on the remote server computing device. The user device can generate a GUI based at least in part on the indexed data structure. For example, the user device may utilize the indexed data structure to generate one or more input selections. The user device can also generate the GUI based other information such as parameters received from the remote server computing system and/or from information in the configuration file. In various implementations, the GUI can include the generated input selections and a textual display of the configuration file. In some implementations, the input selections and textual display can be displayed simultaneously in the GUI, such as in a split view.

The user device may receive a user input indicating modifications of the computing environment configuration. In some implementations, all, or a portion, of the user input may be received via the input selections of the GUI. In some implementations, all, or a portion, of the user input may be received via a change to the textual display of the GUI.

The user device can determine, by referencing the indexed data structure and the location identifiers, one or more changes to the configuration file based on the user input. For example, based on user input of input selections, the user device can determine portions or features of the configuration file associated with the modifications to the computing environment configuration indicated by the user input. The user device can determine, from the indexed data structure, modification location identifiers associated with the portions or features of the configuration file. Each modification location identifier can indicate a location in the configuration file where a modification is to be implemented. The user device can determine, from the user input, changes to the configuration file at each of the modification locations. Examples of changes to the configuration file can include the deletion of one or more characters, the insertion of one or more characters, required syntax or other formatting, and/or other changes to the configuration file.

Each of the one or more changes can be communicated to the remoter server computing device as instructions. The instructions can include the necessary information for the remote server computing device to update the configuration file. For example, the instructions can include modification location identifiers and editing instructions that define the changes, such as deleting and/or inserting characters at the modification location identifiers.

In some implementations, the process for updating a configuration file described above can operate similar to as if a user were to make the changes using a keyboard or other input device directly to the configuration file on the remote server computing device. Such keyboard like updates to the configuration file may occur even when the user input was received via an input selection, such a selectable list. For example, a user may utilize an input selection to select a different input value than was previously present in the configuration file. In this example, the instructions to change the configuration file determined by the user device include a set of keyboard or other input device operations to make the change defined by the different input value. As such, the changes are propagated as if any deletions and insertions were done directly to the configuration file. In some implementations, the process of updating the configuration file on the remote server computing system may allow certain macro operations, such as undo/redo functions, to be utilized on the configuration file. Further, character by character changes may be tracked for version control.

In various implementations, once the configuration file has been updated, the updated configuration file is communicated again to the user devices. The user devices can parse the updated configuration file, generate an updated indexed data structure, and store the updated indexed data structure. In various implementations, each updated configuration file is communicated to the user devices after a wait period (also referred to as a “debounce period”). In some implementations, a transmit period is used to transmit instructions. For example, a user device may communicate instructions of any changes to the configuration file after the transmit period, regardless of whether the user device is to make further changes. The wait period and transmit period may be utilized to propagate real-time, or near real-time updates to the configuration file on the remote server computing device.

### Additional Example Aspects in Overview

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like. A “nondeterministic model” as used in the present disclosure, is any model in which the output of the model is not determined solely based on an input to the model. Examples of nondeterministic models include language models such as LLMs, ML models, and the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. LLMs may work by taking an input text and repeatedly predicting the next word or token (e.g., a portion of a word, a combination of one or more words or portions of words, punctuation, and/or any combination of the foregoing and/or the like). An LLM may be of any type, including a Question Answer (“QA”) LLM that may be optimized for generating answers from a context, a multimodal LLM/model, and/or the like. An LLM (and/or other models of the present disclosure) may include, for example, a NN trained using self-supervised learning and/or semi-supervised learning, a feedforward NN, a recurrent NN, and/or the like. An LLM (and/or other models of the present disclosure) may further include, for example, attention-based and/or transformer architecture or functionality.

While certain aspects and implementations are discussed herein with reference to use of a language model, LLM, and/or AI, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), and BigScience Large Open-science Open-access Multilingual Language Model (BLOOM).

A data store can be any computer-readable storage medium and/or device (or collection of data storage mediums and/or devices). Examples of data stores include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. Another example of a data store is a hosted storage environment that includes a collection of physical data storage devices that may be remotely accessible and may be rapidly provisioned as needed (commonly referred to as “cloud” storage).

A database can be any data structure (and/or combinations of multiple data structures) for storing and/or organizing data, including, but not limited to, relational databases (e.g., Oracle databases, PostgreSQL databases, MySQL databases and the like), non-relational databases (e.g., NoSQL databases, and the like), in-memory databases, spreadsheets, as comma separated values (“CSV”) files, extensible markup language (“XML”) files, TEXT (“TXT”) files, flat files, spreadsheet files, and/or any other widely used or proprietary format for data storage. Databases are typically stored in one or more data stores. Accordingly, each database referred to herein (e.g., in the description herein and/or the figures of the present application) can be understood as being stored in one or more data stores. Additionally, although the present disclosure may show or describe data as being stored in combined or separate databases, in various embodiments such data may be combined and/or separated in any appropriate way into one or more databases, one or more tables of one or more databases, and/or the like.

A data item can be a data representation or container for information representing a specific thing in the world that have a number of definable properties. For example, a data item can represent an entity such as a physical object, a parcel of land or other real property, a market instrument, a policy or contract, or other noun. Each data item may be associated with a unique identifier that uniquely identifies the data item. The item's attributes (e.g. metadata about the object) may be represented in one or more properties. Attributes may include, for example, a geographic location associated with the item, a value associated with the item, a probability associated with the item, an event associated with the item, and so forth.

### II. Example Remote Server Computing Device and Related Computing Environment

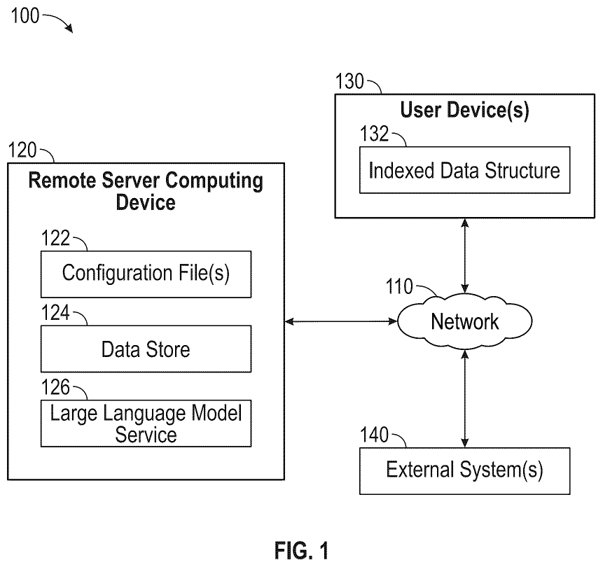

FIG. 1 illustrates an example computing environment 100 including a remote server computing device 120. The remote server computing device 120 can include one or more configuration files 122, a data store 124, and a large language model service 126. The remote server computing device 120 may be connected via network 110 to other computing devices, such as one or more user devices 130 and one or more external systems 140.

### a. Example Remote Server Computing Device

As described above, the remote server computing device 120 remote server computing device can be a computing device that can store one or more configuration files 122, execute and/or store computing environments, host one or more user devices 130, and/or perform other operations. The server computing device 120 can initialize a computing environment from configuration files 122 and allow the user devices 130 to access and/or utilize the computing environment.

A computing environment can be any computing system and/or environment, and can comprise a store of resources, such as computer code, parameters, data, functions, transforms and/or the like. Examples of computing environments can include, but are not limited to, software applications, such a development environments used to create and edit computer code and other software application, servers and/or server process, operating systems, and repositories, to list a few.

In some implementations, a computing environment may be stored centrally on the remote server computing device 120 allowing multiple user devices 130 to access the common resources. For example, in some implementations, the user devices 130 may access the common resources for a shared project. The configuration file(s) 122 can be files of computer code, text, and/or characters used to initialize and/or edit a computing environment configuration. For example, the configuration file can be executed to initialize and/or edit the computer code, parameters, data, functions, transforms and/or the like of a computing environment. The remote server computing device 120 can store the configuration file(s) 122, communicate the configuration file(s) 122 to the user device(s) 130 and/or external system(s) 140.

The data store 124 can include computer-readable storage medium and/or device (or collection of data storage mediums and/or devices). For example, the data store 124 can include, but is not limited to, optical disks, magnetic disks, memory circuits, hosted storage environments, and/or the like. In some implementations, the data store 124 can include one or more databases. The data store 124 can store the computer code, parameters, data, functions, transforms and/or the like associated with one or more a computing environments and/or information for accessing the computer code, parameters, data, functions, transforms and/or the like stored external to the data store 124.

In some implementations, the remote server computing device 120 may receive initialization instructions to compile a new configuration file 122 and/or a new configuration file 122 from the user device(s) 130 and/or external system(s) 140. As described above, the initialization instruction and/or the new configuration file 122 may be based on one or more parameters and/or other information stored on the data store 124 and communicated by the remote server computing device 120 to the user device(s) 130. The user device(s) 130 can use the information received from the remote server computing device 120 to generated one or more setup input selections on a GUI and receive one or more user inputs to determine the initialization instruction and/or the new configuration file 122.

In some implementations, the remote server computing device 120 can receive instructions to change a configuration file 122 from the user device(s) 130 and/or external system(s) 140. As described above, the instruction to change the configuration file can be based, at least in part, on a configuration file 122, one or more parameters and/or other information stored in the data store 124, and/or other sent by the remote server computing device 120 to the user device(s) 130. The user device(s) 130 can use the information received from the remote server computing device 120 to generated one or more input selections on a GUI and receive one or more user inputs to determine the instruction to change the configuration file 122.

The large language model service 126 can provide various LLM-related functionality of the remote server computing device 120. The large language model service 126 may, for example, receive inputs to, and provide outputs from, one or more internal or external LLMs for various LLM functionality of the system described herein. In various implementations, the large language model service 126, and/or one or more LLMs accessible via the large language model service 126, may be locally hosted, cloud managed, accessed via one or more APIs, and/or any combination of the foregoing and/or the like. For example, a user may interact with a user interface provided by the remote server computing device 120 and/or the user device(s) 130, and request to query information associated with a computing environment configuration. The large language model service 126 may receive the query, and transmit results based on the query to the user interface of the remote server computing device 120 and/or user device(s) 130. Examples of LLM output results may include, but are not limited to, completed configuration files, portions or features of configuration files, one or more changes to made to the configuration files, setup input selections, input selections, templates, functions, and/or transforms.

### b. Example User Device(s)

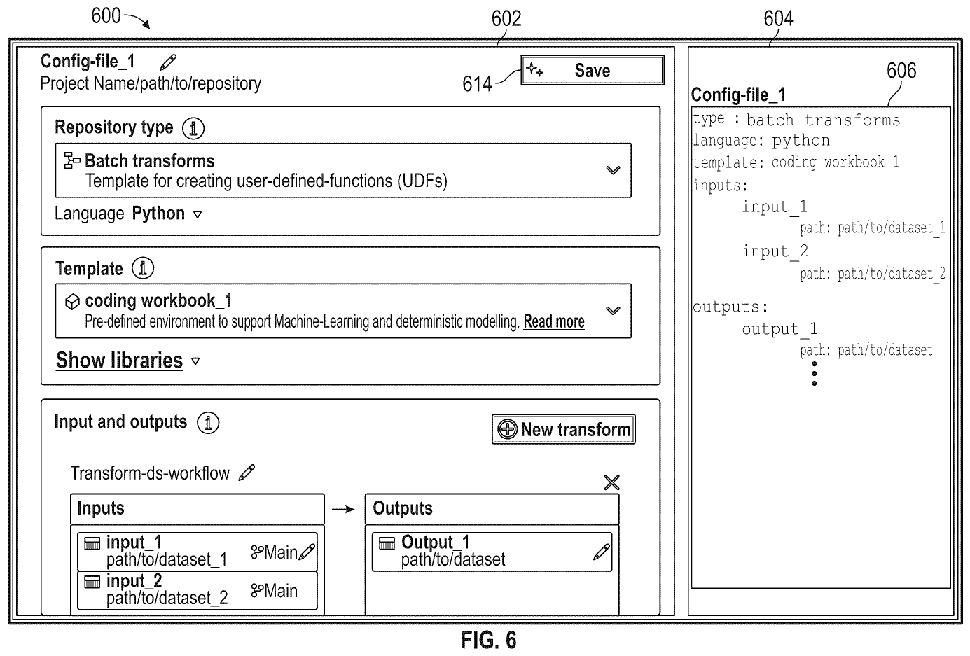

The user device(s) 130 can include a wide variety of computing devices, including personal computing devices, terminal computing devices, laptop computing devices, tablet computing devices, electronic reader devices, mobile devices (e.g., desktop computer, notebook computer, smartphone, or any other type of computing device) and associated software (e.g. a browser capable of rendering output from information provided by, for example, the remote server computing device 120). The user device(s) 130 can provide GUI based tools to users, such as software developers. The users can utilize the GUI to generate and/or edit configuration files 122. In various implementations, the system can provide input selections on the GUI that can be selected and/or edited. The input selections can be used to generate and/or edit the configuration file 122. The input selections can include, but are not limited to, selectable lists, textual input fields, checkboxes, and/or the like. In various implementations, the input selections can be used to select and/or edit a type of the computing environment, one or more coding languages for the computing environment (e.g., Python, JavaScript, Mesa, R, and/or the like), a coding language for the runtime type, libraries, transforms (e.g., containerized transforms), deployed applications, data transformations, inputs and outputs, templates, and/or other aspects of the configuration file 122. Examples of GUIs and input selections utilized by the user device(s) 130 are illustrated in FIGS. 5A-5C and FIG. 6.

As described above, the user device(s) 130 can be utilized to edit configuration files 122. In some implementations, to edit a configuration file 122, the user devices(s) 130 receive the configuration file 122 from the remote server computing device 120. The user device(s) 130 may send a request to edit the a configuration file 122 to the remote server computing device 120 and/or access the configuration file 122 on the remote server computing device 120. Once the user device(s) 130 receives the configuration file 122, the user device(s) 130 can parse the configuration file 122 to generate an indexed data structure 132. The indexed data structure 132 can include location identifiers for each character of the configuration file 122. The characters can include string based characters, return characters, syntax identifiers (e.g., indentation and/or other syntax indicators), and/or other characters of the configuration file 122. The indexed data structure 132 can comprise a linear data structure, an array, a linked list, a stack, a queue, a tree, a graph, and/or any other data structure that can be used to store an association of each character to a location within the configuration file 122. In some implementations, the indexed data structure can include textual representations of portions or features of the configuration file 122 and starting and ending character locations of the portions or features. One example of an indexed data structure 132 is illustrated in FIG. 7.

In various implementations, the user device(s) 130 may store the indexed data structure 132. For example, the user device(s) 130 may store the indexed data structure 132 locally on the user device(s) 130 and/or remotely, such as on the remote server computing device 120 and/or on the external system(s) 140. The user device(s) 130 can generate a GUI based at least in part on the indexed data structure 132. For example, the user device(s) 130 may utilize the indexed data structure 132 to generate one or more input selections. The user device can also generate the GUI based other information such as parameters received from the remote server computing system 120 and/or from information in the configuration file 122. In various implementations, the GUI can include the generated input selections and a textual display of the configuration file 122. In some implementations, the input selections and textual display can be displayed simultaneously in the GUI, such as in a split view.

The user device(s) 130 may receive a user input indicating modifications of the computing environment configuration. In some implementations, all, or a portion, of the user input may be received via the input selections of the GUI. In some implementations, all, or a portion, of the user input may be received via a change to the textual display of the GUI.

The user device(s) 130 can determine, by referencing the indexed data structure 132 and the location identifiers, one or more changes to the configuration file 122 based on the user input. For example, based on user input of input selections, the user device(s) 130 can determine portions or features of the configuration file 122 associated with the modifications to the computing environment configuration indicated by the user input. The user device(s) 130 can determine, from the indexed data structure 132, modification location identifiers associated with the portions or features of the configuration file 122. Each modification location identifier can indicate a location in the configuration file 122 where a modification is to be implemented. The user device(s) 130 can determine, from the user input, changes to the configuration file 122 at each of the modification locations. Examples of changes to the configuration file 122 can include the deletion of one or more characters, the insertion of one or more characters, required syntax or other formatting, and/or other changes to the configuration file 122.

Each of the one or more changes can be communicated to the remoter server computing device 120 as instructions. The instructions can include the necessary information for the server computing device to update the configuration file 122. For example, the instructions can include modification location identifiers and editing instructions that define the changes, such as deleting and/or inserting characters at the modification location identifiers.

In some implementations, the process for updating a configuration file 122 described above can operate similar to as if users of the user device(s) 130 were to make the changes using a keyboard or other input device directly to the configuration file 122 on the remote server computing device 120. Such keyboard like updates to the configuration file 122 may occur even when the user input was received via an input selection, such a selectable list. For example, a user may utilize an input selection to select a different input value than was previously present in the configuration file 122. In this example, the instructions to change the configuration file 122 determined by the user device(s) 130 include a set of keyboard or other input device operations to make the change defined by the different input value. As such, the changes are propagated as if any deletions and insertions were done directly to the configuration file 122. In some implementations, the process of updating the configuration file 122 on the remote server computing system 120 may allow certain macro operations, such as undo/redo functions, to be utilized on the configuration file 122. Further, character by character changes may be tracked for version control.

In various implementations, once the configuration file 122 has been updated, the updated configuration file 122 is communicated to the user device(s) 130 by the remote server computing device 120. The user device(s) 130 can parse the updated configuration file 122, generate an updated indexed data structure 132, and store the updated indexed data structure 132. In various implementations, each updated configuration file 122 is communicated to the user device(s) 130 after a wait period (also referred to as a “debounce period”). In some implementations, a transmit period is used to transmit instructions. For example, user device(s) 130 may communicate instructions of any changes to the configuration file 122 after the transmit period, regardless of whether the user device(s) 130 is to make further changes. The wait period and transmit period may be utilized to propagate real-time, or near real-time updates to the configuration file 122 on the remote server computing device 120.

As described above, the user device(s) 130 can be utilized to generate and/or initialize configuration files 122. In some implementations, to generate and/or initialize a configuration file 122, the user device(s) 130 may generate one or more GUIs with setup input selections. The setup input selections may be the same or different than the input selections used to edit a configuration file 122 that has already initialized a computing environment. For example, some setup input selections that were available to the user when creating a configuration file 122 to initialize the computing environment may be unavailable as input selections to edit the configuration file 122 later. Further, new input selections may become available to edit the configuration file 122 after the computing environment has been initialized, such as, for example, when new resources become available after the computing environment has been initialized.

In some implementations, the input selections available, as setup input selections or otherwise, may be determined by the user device(s) 130 (or the remote server computing device 120) based on the selection of a previous input selection. For instance, the user device(s) 130 may utilize the selection of a type of computing environment, a selected coding language of the computing environment, and/or another input selection to determine one or more additional input selections. As an example, if the computing environment type is selected as a transform (as illustrated in FIGS. 5A-5C), then the system may determine input and output input selections are needed to complete the configuration file 122. However, if the computing environment type is selected as a deployed application, then the system may determine different input selections, such as file paths for the deployment, files to be deployed, and/or the like.

In various implementations, each input selection may be associated with one or more parameters communicated to the user device(s) 130 by the remote server computing device 120 and/or the external system(s) 140. The parameters can provide the appropriate entries for the input selection for a given type of computing environment. For example, for an input selection associated with the coding language, the parameters may provide appropriate languages for the computing environment given the type of the computing environment. In this example, each of the appropriate languages can be presented to a user so the user can select a language for the computing environment. Advantageously, in some implementations, the parameters can ensure the user is presented with entries for an input selection that will work in the computing environment, potentially saving the user time to look up syntax requirements, available functions, data resources, naming conventions, or the like.

In some implementations, the parameters for one input selection may be determined in part based on the selection of one or more previous input selections. For instance, the parameters that define the available values for input and output input selections may be determined in part based on the selection of a coding language, one or more libraries, templates, and/or other selected input selections. As such, only relevant information is associated with each input selection, potentially preventing errors in the configuration file 122. In some implementations, the system may determine the parameters for an input selection based on other factors, such as, for example, security protocols and permissions associated with the user and or the user device(s) 130, security protocols and permissions associated with the computing environment, or security protocols and permissions other sources.

In various implementations, the user device(s) 130 and/or the remote server computing device 120 can store, track, update, and/or perform other operations such that the appropriate parameters are provided for each input selection. For example, the user device(s) 130 and/or the remote server computing device 120 can link parameters to rules, conditions, and/or the like, such as rules associated with a computing environment being initialized or edited. As another example, the user device(s) 130 and/or the remote server computing device 120 can link parameters to another parameter, such as a parameter that is selected at an different input selection. The user device(s) 130 and/or the remote server computing device 120 can also link parameters to security permissions, and/or any other condition that can help determine if a parameter is appropriate for an input selection.

In various implementations, at least a portion of the parameters are associated with the rules of a particular computing environment. For example, the parameters may be defined by the syntax requirements or available functions of a computing environment. In various implementations, at least a portion of the parameters may be received by the system from one or more sources outside the system. In these implementations, the system may track information associated with receiving the parameters, such as source identifiers, querying protocols, and/or other information needed to receive the parameters.

In various implementations, the remote server computing device 120 can initialize a computing environment by communicating one or more parameters to the user device(s) 130 and receiving initialization instructions from the user device with information to generate a configuration file 122 for the computing environment. In these implementations, the user device(s) 130 may generate the initialization instructions based on one or more user inputs. In some implementations, more than one interaction may occur between the user device(s) 130 and the remote server computing device 120. For example, the system may send a first set of parameters, receive a set of input selection values from the user device, and send another set of parameters.

In some implementations, the user device(s) 130 may update the GUIs as the user device(s) 130 receive one or more inputs from a user. For example, based on a first user input, the user device(s) 130 may generate and/or receive from the remote server computing device 120, additional input selections to display on the GUI.

In some implementations, the user device(s) 130 may receive user inputs associated with each of the input selections. In some implementations, the user device(s) 130 may compile each user input, determine the initialization instructions, and communicate the initialization instructions to the system. In other implementations, the user device(s) 130 may communicate each user input as it is received to the remote server computing device 120 and the system can determine the initialization instruction. The initialization instructions can include a version of a configuration file 122 and/or instructions to create the configuration file 122. After receiving the initialization instructions.

### c. Example External System(s)

External system(s) 140 can include computing devices, servers, and/or the like and may perform one or more operations of the remote server computing device 120 or the user device(s) 130 described above. For example, the external system(s) 140 may include one or more models, such as LLMs, that may interact with the remote server computing device 120 and/or user device(s) 130 to perform some or all of the operations of the large language model service 126 described above. The external system(s) 140 may perform other operations, such as providing parameters, functions, templates, data, and/or other information to the remote server computing device 120 and/or user device(s) 130, or other processes, functions, and/or the like described herein and/or known in the art.

### d. Example Network

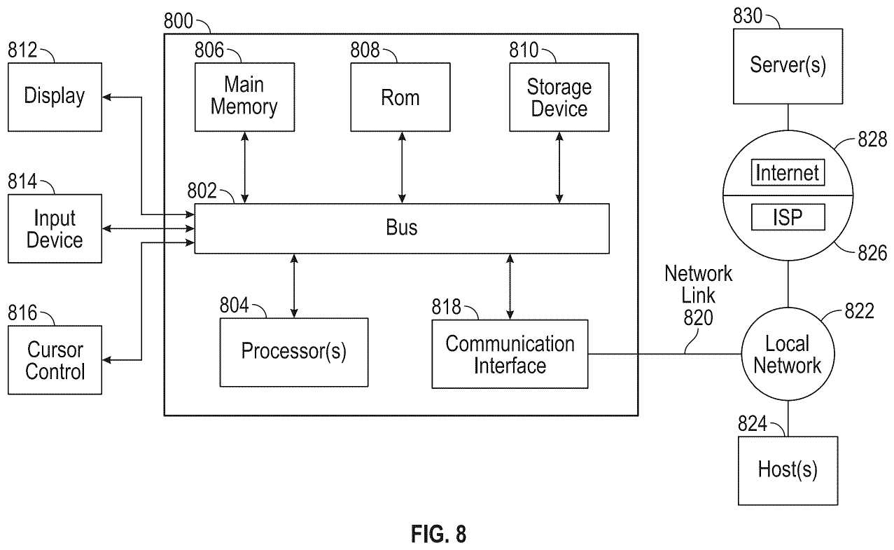

The network 110 can include any one or more communications networks, such as the Internet. The network 110 may be any combination of local area networks (“LAN”) and/or a wireless area networks (“WAN”) or the like. Accordingly, various components of the computing environment 100, including the remote server computing device 120 and the user device(s) 130, can communicate with one another directly or indirectly via any appropriate communications links and/or networks, such as network 110 (e.g., one or more communications links, one or more computer networks, one or more wired or wireless connections, the Internet, any combination of the foregoing, and/or the like). Similarly, the various components (e.g., as described below) of the remote server computing device 120 and the computing environment 100 may, in various implementations, communicate with one another directly or indirectly via any appropriate communications links (e.g., one or more communications links, one or more computer networks, one or more wired or wireless connections, the Internet, any combination of the foregoing, and/or the like). FIG. 8 described below, provides additional examples of aspects of implementations of such components of the computing environment 100, the remote server computing device 120, the user device(s) 130, and the like.

### III. Example Functionality of the User Device(s) and the Remote Server Computing Device

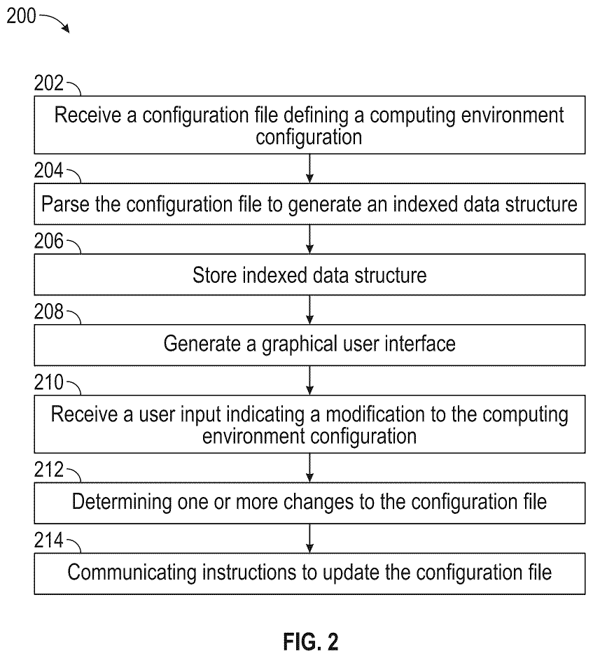

FIGS. 2-4 show flow charts illustrating example operations of the remote server computing device 120, the user device(s) 130, and/or various other aspects of the example computing environment 100, according to various implementations. The blocks of the flow charts illustrate example implementations, and in various other implementations various blocks may be rearranged, optional, and/or omitted, and/or additional block may be added. In various implementations, the example operations illustrated in FIGS. 2-4 may be computer-implemented, for example, by the one or more aspects of the remote server computing device 120, the user device(s) 130, various other aspects of the example computing environment 100, and/or the like.

FIG. 2 is a flow chart depicting an example process 200 for editing a configuration file stored on a remote server computing device using a user device. As noted above, a user of a user device may wish to edit a configuration file to redefine or otherwise alter the computing environment. Editing the configuration file may present challenges. One such challenge may be version control. Once a computing environment has been initialized, it may be utilized by multiple users, such as by multiple users, functions, other computing environments, and/or the like. In some instances, it may be desirable or necessary for all users to access the same version of the computing environment, use the same version of the computing environment and/or track the current version of the computing environment. As such, one aspect of the challenge of version control is ensuring consistency of the configuration file for each user. Another aspect of the challenge of version control is tracking changes within the configuration file. In some instances, it may be desirable to track changes for each character of the configuration file as the changes occur. Process 200 may advantageously address some or all of the challenges above and/or other challenges not mentioned.

At block 202, the user device receives a configuration file defining a computing environment configuration. The user device may send a request to edit the configuration file to the remote server computing device and/or access the configuration file on the remote server computing device. The remote server computing device can send the configuration file to the user device. As noted above, a computing environment can be any computing system and/or environment, and can comprise a store of resources, such as computer code, parameters, data, functions, transforms and/or the like. Examples of computing environments can include, but are not limited to software applications, such a development environments used to create and edit computer code and other software application, servers and/or server process, operating systems, and repositories, to list a few. A configuration file can be files of computer code, text, and/or characters used to initialize and/or edit a computing environment configuration. For example, the configuration file can be executed to initialize and/or edit the computer code, parameters, data, functions, transforms and/or the like of the computing environment.

At block 204, the user device parses the received configuration file to generate an indexed data structure. The indexed data structure can include location identifiers for each character of the configuration file. The characters can include string based characters, return characters, syntax identifiers (e.g., indentation and/or other syntax indicators), and/or other characters of the configuration file. The indexed data structure can comprise a linear data structure, an array, a linked list, a stack, a queue, a tree, a graph, and/or any other data structure that can be used to store an association of each character to a location within the configuration file. In some implementations, the indexed data structure can include textual representations of portions or features of the configuration file and starting and ending character locations of the portions or features. One example of an indexed data structure is illustrated and described in reference to FIG. 7.

At block 206, the user device stores the indexed data structure. For example, the user device may store the indexed data structure locally on the user device and/or remotely, such as on the remote server computing device.

At block 208, the user device generates a graphical user interface (“GUI”). The user device can generate a GUI based at least in part on the indexed data structure. For example, the user device may utilize the indexed data structure to generate one or more input selections. The user device can also generate the GUI based other information such as parameters received from the remote server computing device and/or from information in the configuration file. In various implementations, the GUI can include the generated input selections and a textual display of the configuration file. In some implementations, the input selections and textual display can be displayed simultaneously in the GUI, such as in a split view.

At block 210, the user device receives a user input indicating a modification to the computing environment configuration. In some implementations, all, or a portion, of the user input may be received via the input selections of the GUI. In some implementations, all, or a portion, of the user input may be received via a change to the textual display of the GUI.

At block 212, the user device determines, by reference to the indexed data structure and the location identifiers, and based on the user input, one or more changes to the configuration file. For example, based on user input of input selections, the user device can determine portions or features of the configuration file associated with the modifications to the computing environment configuration indicated by the user input. The user device can determine, from the indexed data structure, modification location identifiers associated with the portions or features of the configuration file. Each modification location identifier can indicate a location in the configuration file where a modification is to be implemented. The user device can determine, from the user input, changes to the configuration file at each of the modification locations. Examples of changes to the configuration file can include the deletion of one or more characters, the insertion of one or more characters, required syntax or other formatting, and/or other changes to the configuration file.

At block 214, the user device communicates instruction to update the configuration file to the remote server computing device. The instructions can include the necessary information for the remote server computing device to update the configuration file. For example, the instructions can include modification location identifiers and editing instructions that define the changes, such as deleting and/or inserting characters at the modification location identifiers.

In some implementations, the process 200 can be repeated after the configuration file is updated. For example, once the configuration file has been updated, the updated configuration file can be communicated again to the user devices. The user devices can parse the updated configuration file, generate an updated indexed data structure, and store the updated indexed data structure. In various implementations, each updated configuration file is communicated to the user devices after a wait period (also referred to as a “debounce period”). In some implementations, a transmit period is used to transmit instructions. For example, a user device may communicate instructions of any changes to the configuration file after the transmit period, regardless of whether the user device is to make further changes. The wait period and transmit period may be utilized to propagate real-time, or near real-time updates to the configuration file on the remote server computing device.

In various implementations, process 200 can be performed for every user input. For example, the user device may determine changes to the configuration file, communicate instructions to update the configuration file, receive an updated configuration file, generate an updated indexed data structure, store the updated indexed data structure, and generate an updated GUI each time the user makes a change to the configuration file (e.g., for every character typed by the user on the textual display, for every input selection the user selects, and/or other user changes to the configuration file). In various implementations, all, or a portion, of process 200 can be performed based on other factors. For example, all, or a portion, of process 200 may be performed after the user device receives a threshold number of user inputs, after a threshold amount of time (e.g., the denounce period noted above), based on other occurrences, or any combination thereof.

In some implementations, the process 200 for editing a configuration file described above can operate similar to as if a user were to make the changes using a keyboard or other input device directly to the configuration file on the remote server computing device. Such keyboard like updates to the configuration file may occur even when the user input was received via an input selection, such a selectable list. For example, a user may utilize an input selection to select a different input value than was previously present in the configuration file. In this example, the instructions to change the configuration file determined by the user device include a set of keyboard or other input device operations to make the change defined by the different input value. As such, the changes are propagated as if any deletions and insertions were done directly to the configuration file. In some implementations, the process of updating the configuration file on the remote server computing device may allow certain macro operations, such as undo/redo functions, to be utilized on the configuration file. Further, character by character changes may be tracked for version control.

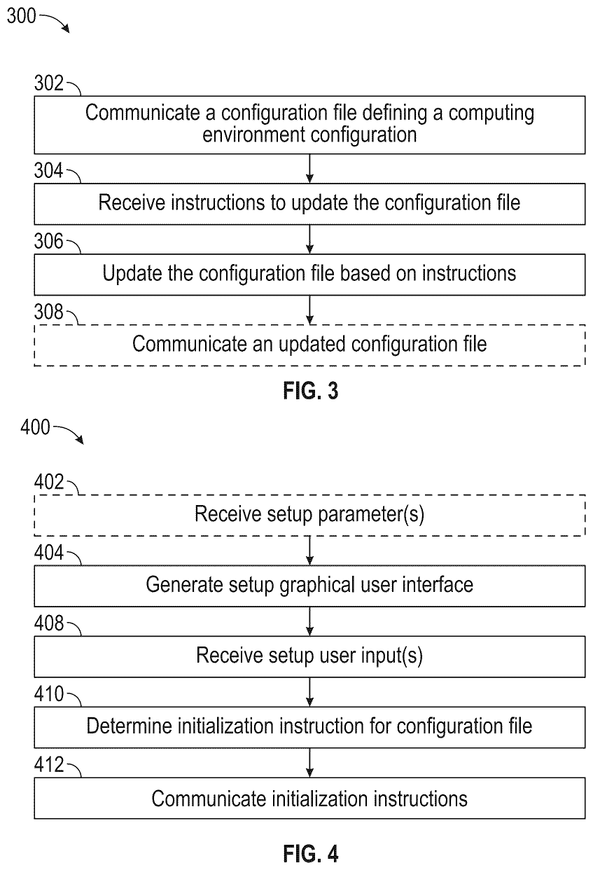

FIG. 3 is a flow chart depicting an example process 300 for updating a configuration file using a remote server computing device. In some implementations, process 300 is performed by a remote server computing device in association with process 200. As such, process 300 may address many of the same challenges described above.

At block 302, the remote server computing device communicates a configuration file defining a computing environment to one or more user devices. The remote server computing device may receive a request to edit the configuration file from the user device and/or the user device may access the configuration file on the remote server computing device. In some implementations, the remote server computing device may also communicate additional information, such as parameters or other information stored on the remote server computing device, to the user devices. As described above respective to Process 200, the user devices may use the configuration file and additional information and determine instructions to update the configuration file.

At block 304, the remoter server computing device receives instructions to update the configuration file from a user device. The instructions can include the necessary information for the remote server computing device to update the configuration file. For example, the instructions can include modification location identifiers and editing instructions that define the changes, such as deleting and/or inserting characters at the modification location identifiers.

At block 306, the remote server computing device updates the configuration file based on the instructions. In some implementations, the process for updating a configuration file can operate similar to as if a user were to make the changes using a keyboard or other input device directly to the configuration file on the remote server computing device. For example, the instructions to change the configuration file can include a set of keyboard or other input device operations to make changes in the configuration file a specific locations. In some implementations, the remote server computing device may retain certain macro operations, such as undo/redo functions, within the configuration file. Further, the remote server computing device may track character by character changes for version control.

At block 308, the remote server computing device may optionally communicate the updated configuration file to the user devices. This can allow the user devices to parse the updated configuration file, generate updated indexed data structures, and store the updated indexed data structures. In various implementations, each updated configuration file is communicated to the user devices after a wait period (also referred to as a “debounce period”). In some implementations, a transmit period is used to transmit instructions. For example, a user device may communicate instructions of any changes to the configuration file after the transmit period, regardless of whether the user device is to make further changes. The wait period and transmit period may be utilized to propagate real-time, or near real-time updates to the configuration file on the remote server computing device.

FIG. 4 is a flow chart depicting an example process 400 for initializing a configuration file stored on a remote server computing device using a user device. As noted above, authoring a configuration file for a computing environment can be challenging. ne software development Each computing environment may have unique rules, restrictions, formats, sensitivities, and/or other attributes that can alter how a configuration file must be authored for that particular computing environment. As such, users can spend significant time searching documentations and/or other information sources to identify syntax requirements, available functions, data resources, naming conventions, and/or other attributes for generating a configuration file for a computing environment. Process 400 may advantageously address some or all of the challenges above and/or other challenges not mentioned. Process 400

At block 402, the user device optionally receives one or more setup parameters from the remote server computing device. The setup parameters can provide the appropriate entries for input selections of a GUI generated by the user device, such as the GUI generated below at block 404. In various implementations, each input selection may be associated with one or more of the parameters. The parameters can provide the appropriate entries for the input selection for a given type of computing environment. For example, for an input selection associated with the coding language, the parameters may provide appropriate languages for the computing environment given the type of the computing environment. In this example, each of the appropriate languages can be presented to a user so the user can select a language for the computing environment. Advantageously, in some implementations, the parameters can ensure the user is presented with entries for an input selection that will work in the computing environment, potentially saving the user time to look up syntax requirements, available functions, data resources, naming conventions, or the like.

In some implementations, the parameters for one input selection may be received and/or determined in part based on the selection of one or more previous input selections. For instance, the parameters that define the available values for input and output input selections may be determined in part based on the selection of a coding language, one or more libraries, templates, and/or other selected input selections. As such, only relevant information is associated with each input selection, potentially preventing errors in the configuration file. In some implementations, the remote server computing device and/or user device may determine the parameters for an input selection based on other factors, such as, for example, security protocols and permissions associated with the user, security protocols and permissions associated with the computing environment, or security protocols and permissions other sources.

In various implementations, the remote server computing device can store, track, update, and/or perform other operations such that the appropriate parameters are provided to the user device for each input selection. For example, the remote server computing device can link parameters to rules, conditions, and/or the like, such as rules associated with a computing environment being initialized or edited. As another example, the remote server computing device can link parameters to another parameter, such as a parameter that is selected at an different input selection. The remote server computing device can also link parameters to security permissions, and/or any other condition that can help determine if a parameter is appropriate for an input selection.

In various implementations, at least a portion of the parameters are associated with the rules of a particular computing environment. For example, the parameters may be defined by the syntax requirements or available functions of a computing environment. In various implementations, at least a portion of the parameters may be received by the remote server computing device and/or user device from one or more sources outside the remote server computing device and/or user device. In these implementations, the remote server computing device and/or user device may track information associated with receiving the parameters, such as source identifiers, querying protocols, and/or other information needed to receive the parameters.

At block 404, the user device generates a setup graphical user interface (“GUI”). The setup GUI may be the same or different as other GUIs described herein. In some implementations the setup GUI is configured to display setup input selections. As noted above, input selections can be used to generate or edit the configuration file. The input selections can include, but are not limited to, selectable lists, textual input fields, checkboxes, and/or the like. In various implementations, the input selections can be used to select a type of the computing environment, one or more coding languages for the computing environment (e.g., Python, JavaScript, Mesa, R, and/or the like), a coding language for the runtime type, libraries, transforms (e.g., containerized transforms), deployed applications, data transformations, inputs and outputs, templates, and/or other aspects of the configuration file.

In various implementations, before a computing environment has been initialized, input selections may be referred to as setup input selections. The setup input selections may be the same or different than the input selections used to edit a configuration file that has already initialized a computing environment, such as the input selections discussed in process 200 and process 300. For example, some setup input selections that are available to the user when creating a configuration file to initialize the computing environment (e.g., during process 400) may be unavailable as input selections to edit the configuration file later (e.g., during process 200 or process 300). Further, new input selections may become available to edit the configuration file after the computing environment has been initialized, such as, for example, when new resources become available after the computing environment has been initialized.

In some implementations, the input selections available, as setup input selections or otherwise, may be determined based on the selection of a previous input selection. For instance, the remote server computing device and/or user device may utilize the selection of a type of computing environment, a selected coding language of the computing environment, and/or another input selection to determine one or more additional input selections. As an example, if the computing environment type is selected as a transform (as, for example, illustrated in FIGS. 5A-5C), then the remote server computing device and/or the user device may determine which input and output input selections are needed to complete the configuration file. However, if the computing environment type is selected as a deployed application, then the remote server computing device and/or the user device may determine different input selections, such as file paths for the deployment, files to be deployed, and/or the like.

The user device may generate and/or receive from the remote server computing device, the setup GUI based on the parameters received at block 402. The setup GUI can include one or more setup input selections described above. In some implementations, the setup GUI may be updated as the user device receive one or more inputs from a user at block 408. For example, based on a first user input, the user device may generate and/or receive from the remote server computing device and/or the user device, additional input selections to display on the setup GUI.

At block 408, the user device receives one or more setup user inputs. Each setup user input may be associated with a setup input selections made by a user on the setup GUI. In some implementations, the user device may compile each setup user input.

At block 410, the user device determines initialization instruction for a configuration file. In some implementations, the user device may user the setup user input to determine the initialization instructions and communicate the initialization instructions to the remote server computing device. In other embodiments, the user device may communicate each user input as it is received to the remote server computing device and the remote server computing device can determine the initialization instruction. The initialization instructions can include a version of a configuration file and/or instructions to create the configuration file, including necessary information for the remote server computing device initialize the configuration file. For example, the initialization instructions can include information such as computing environment types, languages, templates, inputs, outputs, or other information used by the configuration file.

At block 412, the user device communicates the initialization instructions to the remote server computing device. In some implementations, after receiving the initialization instructions, the remote server computing device can create and/or execute the configuration file to initialize the computing environment.

In some implementations, all, or a portion of the configuration file, input selections, and/or parameters discussed above in process 200, process 300, and/or process 400 may be determined in part using one or more models, such as LLMs. For example, a user may provide a set of inputs, such as a portion of the input selections, to a LLM and prompt the LLM to create the configuration file, edit the configuration file, to provide input selections and/or to provide parameters for the input selections, to list a few.

### IV. Example Graphical User Interfaces

FIGS. 5A-5C and 6 illustrate example graphical user interfaces as provided by, for example, the user device(s) 130. While some aspects described in FIGS. 5A-5C and 6 are directed to a repository, some, or all, of the aspects described in FIGS. 5A-5C and 6 may also be applicable to other computing environments. Further, while FIGS. 5A-5C and 6 illustrate examples input selections, other input selections may be utilized by a user device and/or a server computing system, to author and/or edit a configuration file. The graphical user interface, input selections, and other features depicted in FIGS. 5A-5C and 6 may be generated, transmitted, and/or otherwise used as described above. For example, the graphical user interfaces may be generated based in part on indexed data structures, configuration files, parameters, and/or other information described in process 200, 300, and 400, or elsewhere in this description. As another example, the input selections may be used to receive one or more user inputs, determine changes to configuration files, determine modification location identifiers, determine instructions to update the configuration file, and/or other information described in process 200, 300, and 400, or elsewhere in this description.

FIGS. 5A-5C illustrate an example GUI 500 permitting a user to select various input selections for a configuration file used to initialize a computing environment. While features, illustrations, and descriptions associated with GUI 500 are described in association with initializing a computing environment, some, or all, of the features, illustrations, and descriptions may also apply to changing and/or updating a configuration file associated with a previously initialized computing environment. As noted above, the system, such as a user device, can provide input selections on a GUI that can be selected and/or edited. The input selections can be used to generate and/or edit the configuration file. The input selections can include, but are not limited to, selectable lists, textual input fields, checkboxes, and/or the like. The input selections may be based in part on one or more parameters, an existing configuration file, and/or other information received by and/or stored on the user device.

Referring to FIG. 5A, GUI 500 can include a computing environment type input selection 502, a language input selection 504, a template input selection 506, a show libraries input selection 508, one or more input and outputs input selections 512, a new transform input selection 510, and a start computing environment input selection 514.

In some implementations, a user can utilize the computing environment type input selection 502 to select a computing environment type to configure. Examples of computing environment types can include, but are not limited to software applications, such a development environments used to create and edit computer code and other software application, servers and/or server process, operating systems, and repositories, to list a few. In some implementations, a user can utilize the computing environment type input selection 502 (and/or another input selection) to define a computing environment subtypes. For example, the computing environment type input selection 502 may be used to define a repository type. Repository types can include, but are not limited to, transforms (e.g., batch transforms containerized transforms, or other transforms), deployed applications, data repositories (e.g., data warehouses, data lakes, data marts, metadata repositories, data cubes, or other data repositories), to list a few.

In some implementations, a user can utilize the language input selection 504 to select a language associated with the computing environment. The language can be associated with coding languages, such as Python, JavaScript, R, and/or other coding languages used by the computing environment. In some implementations the language selected at the language input selection 504 may define a runtime type for one or more portions and/or features of the computing environment. Referring to FIG. 5B, in some implementations, when language input selection 504 is selected by a user, the GUI 500 can display input selection 504a. Input selection 504a can allow a user to select one or more languages from a dropdown list. In some implementations, input selection 504a can include searching functionality and/or filtering functionality to allow a user to quickly navigate the languages. In some implementations, the input selection 504a can include recommended languages. The recommended languages may be based on a type and/or subtype of the computing environment and/or other considerations.

In some implementations, a user can utilize the template input selection 506 to select one or more templates for the computing environment. The templates can include populated selections for one or more other input selections (e.g., prepopulated inputs and outputs for one or more input and outputs input selections 512), selections of previously defined and/or initialized computing environment, selections of resources bundled for specific types of applications (e.g., a pre-defined environment to support Machine-Learning and deterministic modeling used by a computing environment) and/or other options for the computing environment. Referring to FIG. 5C, in some implementations, when a user selects template input selection 506, GUI 500 can display input selection 506a. Input selection 506a may provide a list or other display of options of selectable templates. In some implementations, input selection 506a may display included resources, such as libraries, languages, and/or other resources associated with each selectable template. For example, as a user highlights, holds a cursor over, or otherwise indicates a selectable template, the input selection 506a may display the resources associated with that selectable template.

Referring again to FIG. 5A, a user may utilize the show libraries input selection 508 to view and/or edit the current libraries associated with the computing environment. The libraries may have been previously defined by other input selections, such as computing environment type input selection 502, language input selection 504, and/or template input selection 506. The libraries may be associated with one or more resources and/or other information used by and/or to define a computing environment.

In the illustrated example, one or more input and outputs input selections 512 may be used by a user to define one or more inputs and/or one or more outputs associated with transformations. A user may utilize new transform input selection 510 to add additional transforms to the one or more input and outputs input selections 512. Each input and/or output may be associated with a file path and/or storage location of input and/or output. Each input may be a resource that is utilized by the computing environment (e.g., in a transform of the computing environment).

A user may utilize the start computing environment input selection 514 to submit, save, and/or complete the user inputs from the input selections. In some implementations, the start computing environment input selection 514 causes the user device to compile a configuration file, compile instructions to edit a configuration file, transmit a configuration file, transmit instructions to edit a configuration file and/or otherwise cause a configuration file to be added to or changed on a remote server computing device. In some implementations, the start computing environment input selection 514 may be omitted. In such implementation, information may be transmitted to the remote server computing device as the changes occur or based on a set period, such as a debounce or transmission period.

In some implementations, some or all of the input selections depicted in FIGS. 5A-5C may be interrelated. For example, one or more input and outputs input selections 512 may be displayed on the GUI 500 based on the user selection at computing environment type input selection 502. As such, if a user selects a different input selection than is illustrated in GUI 500, different input selections may be presented to the user on GUI 500. For example, if a user utilizes computing environment type input selection 502 to select a deployed action rather than a transform, other input selections may be presented on the GUI 500.

FIG. 6. illustrates an example GUI 600 permitting a user to select various input selections for a configuration file used to edit and/or initialize a computing environment. In the illustrated example, GUI 600 includes a first interface 602 and a second interface 604. The first interface 602 can include all, or a portion, of the features of GUI 500. As illustrated in FIG. 6, the first interface 602 can include a save computing environment input selection 614. The save computing environment input selection 614 can include all, or a portion, of the features of start computing environment input selection 514 described above. In the illustrated example, save computing environment input selection 614 is used to save any changes made to the configuration file in GUI 600. However, in some implementations, the save computing environment input selection 614 may be used to cause the user device to compile a configuration file, compile instructions to edit a configuration file, transmit a configuration file, transmit instructions to edit a configuration file and/or otherwise cause a configuration file to be added to or changed on a remote server computing device. Further, in some implementations, the save computing environment input selection 614 may be omitted. In such implementation, information may be saved and/or transmitted to the remote server computing device as the changes occur or based on a set period, such as a debounce or transmission period.

In some implementations, GUI 600 can include a text editor 604. The text editor 604 can include a textual display of a textual representation of the configuration file 606 and/or other file containing text. In some implementations, a user may use the text editor 604 to edit the text of a textual representation of the configuration file 606 directly. The changes a user makes to the textual representation of the configuration file 606 using the text editor text 604 may be captured and communicated to the remote server computing device in a manner similar as changes using one or more input selections.

In some implementations, the first interface 602 and the text editor 604 can display active changes in the configuration file, even if the changes are implemented by the other of the first interface 602 and the text editor 604. For example, a user may use the interface 602 to make a change to the configuration file, which are reflected in the textual representation of the configuration file 606. Similarly, changes made to the configuration file in the textual representation of the configuration file 606 may be reflected in the first interface 602. In some implementations, the user device keeps a local copy of the configuration file and saves any changes locally. In such implementations, the changes may be transmitted by the user device to the remote server computing device bundled. In some implementations, the user device transmits each change as they occur (and/or after a set time period, such as a debounce period) and receives and displays updates to the configuration file after each change (and/or time period).

### V. Example Indexed Data Structure

FIG. 7 illustrates an example indexed data structure 700. The indexed data structure 700 may be utilized by a user device, such as the user device(s) 130, to edit, update, analyze and/or track a configuration file, and/or otherwise interact with a configuration file. In some implementations, indexed data structure 700 may be generated and stored by process 200 of FIG. 2. In some implementations, indexed data structure 700 may be associated with a configuration file generated from user inputs associated with, for example, GUI 500 of FIGS. 5A-5C and/or GUI 600 of FIG. 6.

In various implementations, the indexed data structure 700 can include indications of start location identifier, identifying a location of the first character in the configuration file (e.g., location “1” illustrated in indexed data structure 700). The indexed data structure 700 can also include an end location identifier, identifying a location of the last character in the configuration file (e.g., location “590” illustrated in indexed data structure 700).

In various implementations, the indexed data structure 700 can include one or more sections, such as section 702 and section 704. Each section can include a start location identifier, an end location identifier, and a type identifier. In the illustrated example, section 702 comprises a “type” section associated with a type of computing environment initialized by the configuration file. Section 702 is illustrated with a start location identifier, “7”, indicating the first character of section 702 is at location 7 in the configuration file and with an end location identifier, “22”, indicating the last character of section 702 is at location 22 in the configuration file. Section 702 is illustrated with a “batch transform” type identifier, indicating that the computing environment associated with the configuration file is a batch transform type.

In the illustrated example, section 704 comprises a “language” section associated with a language of the computing environment initialized by the configuration file. Section 704 is illustrated with a start location identifier, “32”, indicating the first character of section 704 is at location 32 in the configuration file and with an end location identifier, “38”, indicating the last character of section 702 is at location 38 in the configuration file. Section 704 is illustrated with a “python” type identifier, indicating that Python is used as language of the computing environment initialized by the configuration file.

Each section of the indexed data structure 700 may be used to populate input selections of a GUI For example, a user device may parse a configuration file to create the indexed data structure 700 and generate GUI 500 of FIGS. 5A-5C and/or GUI 600 of FIG. 6. Further, a user device may use indexed data structure 700 to generate and communicate instructions to a remote server computing device. For example, a user device may receive a user input to change the language at language input selection 504 of GUI 500 from Python to JavaScript. In this example, the user device can generate instructions for the server computing device to make the alterations to the configuration file beginning at location 32. The server computing device can then alter the configuration file and send an updated configuration file to the user device. The user device may then update the indexed data structure 700 to reflect the changes (e.g., change the type of section 704 to “JavaScript” and/or change the start and/or end location identifiers, if different).

Indexed data structure 700 can include a section for each portion or feature of the configuration file. Further, each section, may have nested sections and/or subsections. For example, one section may include multiple portions or features of the configuration file that can be authored and/or altered by the user device. Indexed data structure 700 provides an example of an indexed data structure that may be used by the by a user device to edit, update, analyze and/or track a configuration file, and/or otherwise interact with a configuration file and other implementations of indexed data structures may be used. For example, an indexed data structure may include different textual representations of features or portions of the configuration file than is illustrated in FIG. 7. In various implementation, an indexed data structure may include other representations of features or portions of the configuration file, such as functions, computer-readable code, mathematical expressions, and/or other representations of features or portions of the configuration file. In some implementations, an indexed data structure may include both textual and other representations of features or portions of the configuration file. Further, as noted above, an indexed data can comprise a linear data structure, an array, a linked list, a stack, a queue, a tree, a graph, and/or any other data structure that can be used to store an association of each character to a location within the configuration file.

### VI. Additional Example Implementations and Details

In an implementation the system (e.g., one or more aspects of the remote server computing device 120, one or more aspects of the user device(s) 130, one or more aspects of the computing environment 100, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 8) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In some implementations the virtual computing environment may comprise one or more virtual machines, containers, and/or other types of emulations of computing systems or environments. In some implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 8 shows a block diagram that illustrates a computer system 800 upon which various implementations and/or aspects (e.g., one or more aspects of the computing environment 100, one or more aspects of the remote server computing device 120, one or more aspects of the user device(s) 130, one or more aspects of the external system(s) 140, and/or the like) may be implemented. Multiple such computer systems 800 may be used in various implementations of the present disclosure. Computer system 800 includes a bus 802 or other communication mechanism for communicating information, and a hardware processor, or multiple processors, 804 coupled with bus 802 for processing information. Hardware processor(s) 804 may be, for example, one or more general purpose microprocessors.

Computer system 800 also includes a main memory 806, such as a random-access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions. The main memory 806 may, for example, include instructions to implement server instances, queuing modules, memory queues, storage queues, user interfaces, and/or other aspects of functionality of the present disclosure, according to various implementations.

Computer system 800 further includes a read only memory (ROM) 808 or other static storage device coupled to bus 802 for storing static information and instructions for processor 804. A storage device 810, such as a magnetic disk, optical disk, or USB thumb drive (Flash drive), and/or the like, is provided and coupled to bus 802 for storing information and instructions.

Computer system 800 may be coupled via bus 802 to a display 812, such as a cathode ray tube (CRT) or LCD display (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computing system 800 may include a user interface module to implement a GUI that may be stored in a mass storage device as computer executable program instructions that are executed by the computing device(s). Computer system 800 may further, as described below, implement the techniques described herein using customized hard-wired logic, one or more ASICs or FPGAs, firmware and/or program logic which in combination with the computer system causes or programs computer system 800 to be a special-purpose machine. According to one implementation, the techniques herein are performed by computer system 800 in response to processor(s) 804 executing one or more sequences of one or more computer-readable program instructions contained in main memory 806. Such instructions may be read into main memory 806 from another storage medium, such as storage device 810. Execution of the sequences of instructions contained in main memory 806 causes processor(s) 804 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN (or WAN component to communicated with a WAN). Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### VII. Example Clauses

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computer-implemented method for remotely modifying a configuration file defining a computing environment configuration, the computer-implemented method comprising, by one or more hardware processors executing program instructions: receiving, from a remote server computing device, a configuration file defining a computing environment configuration; parsing the configuration file to generate an indexed data structure, the indexed data structure comprising location identifiers of characters of the configuration file; storing the indexed data structure; generating a graphical user interface based at least in part on the indexed data structure; receiving, via the graphical user interface, a user input indicating a modification to the computing environment configuration; determining, by reference to the indexed data structure and the location identifiers, and based on the user input, one or more changes to the configuration file; and communicating, to the remote server computing device, instructions to update the configuration file in accordance with the one or more changes.

Clause 2. The computer-implemented method of Clause 1, wherein the indexed data structure comprises at least one of: a linear data structure, an array, a linked list, a stack, a queue, a tree, or a graph.

Clause 3. The computer-implemented method of any of Clauses 1-2, wherein the graphical user interface comprises one or more input selections, each input selection associated with at least a portion of the configuration file.

Clause 4. The computer-implemented method of Clause 3, wherein the one or more input selections are generated based on the indexed data structure and parameters defining one or more options for the computing environment configuration.

Clause 5. The computer-implemented method of Clause 4, wherein the computer-implemented method further comprises, by the one or more hardware processors executing program instructions: receiving the parameters from the remote server computing device.

Clause 6. The computer-implemented method of any of Clauses 3-5, wherein the graphical user interface further comprises a textual display of the configuration file.

Clause 7. The computer-implemented method of Clause 6, wherein the user input comprises at least one of a change to the textual display of the configuration file or a selection of an input selection of the one or more input selections.

Clause 8. The computer-implemented method of any of Clauses 1-7, wherein determining the one or more changes to the configuration file comprises: determining, based on the user input, a portion of the configuration file associated with the modification to the computing environment configuration; determining, from the indexed data structure, at least a first modification location identifier, of the location identifiers, associated with the portion of the configuration file, wherein the first modification location identifier indicates a location in the configuration file where the modification is to be implemented; and determining at least a first change, of the one or more changes, to be made to characters of the configuration file as identified by the first modification location identifier.

Clause 9. The computer-implemented method of any of Clauses 1-8, wherein the one or more changes to the configuration file comprise a deletion of at least one character of the configuration file.

Clause 10. The computer-implemented method any of Clauses 1-9, wherein the one or more changes to the configuration file comprise an addition of at least one character to the configuration file.

Clause 11. The computer-implemented method of any of Clauses 8-10, wherein the instructions to update the configuration file comprise: one or more modification location identifiers, including at least the first modification location identifier, for each of the one or more changes; and editing instructions configured to cause the remote server computing device to edit the configuration file based on the one or more changes and associated one or more modification location identifiers.

Clause 12. The computer-implemented method of Clause 11, wherein the editing instructions comprise at least one of: an instruction to add at least one character or an instruction to delete at least one character.

Clause 13. The computer-implemented method of an of Clauses 11-12, wherein the remote server computing device is configured to: receive the instructions to update the configuration file; and for each of the one or more changes, execute the associated editing instructions to edit the configuration file in accordance with the editing instructions.

Clause 14. The computer-implemented method of any of Clauses 1-13, wherein the computer-implemented method further comprises, by the one or more hardware processors executing program instructions: receiving, from the remote server computing device, an updated configuration file defining an updated computing environment configuration; parsing the updated configuration file to generate an updated indexed data structure, the updated indexed data structure comprising location identifiers of each character of the updated configuration file; and storing the updated indexed data structure.

Clause 15. The computer-implemented method of any of Clauses 1-14, wherein the computer-implemented method further comprises, by the one or more hardware processors executing program instructions: generating a setup graphical user interface comprising one or more setup input selections, each setup input selection of the one or more setup input selections associated with a setup parameter for the computing environment configuration; receiving, via the setup graphical user interface, a setup user input associated with each of the one or more setup input selections; determining, based on the setup user input, initialization instructions for the configuration file; and communicating, to the remote server computing device, the initialization instructions.

Clause 16. The computer-implemented method of Clause 15, wherein the computer-implemented method further comprises, by the one or more hardware processors executing program instructions: receiving, from the remote server computing device, setup parameters associated with each setup input selection of the one or more setup input selections.

Clause 17. The computer-implemented method of Clause 15, wherein the initialization instructions are configured to cause the remote server computing device to generate the configuration file.

Clause 18. The computer-implemented method of any of Clauses 1-17, wherein the computer-implemented method further comprises, by the one or more hardware processors executing program instructions: communicating, to a large language model (“LLM”), a prompt comprising at least: a user input, and one or more items of information associated with the computing environment configuration; and receiving, from the LLM, an output indicative of at least one of: the configuration file, one or more changes to be made to the configuration file, at least one setup input selection, or at least one input selection.

Clause 19. A system comprising: one or more computer-readable storage mediums having program instructions embodied therewith; and one or more processors configured to execute the program instructions to cause the system to perform the computer-implemented method of any of Clauses 1-18.

Clause 20. A computer program product comprising one or more computer-readable storage medium having program instructions embodied therewith, the program instructions executable by one or more processors to cause the one or more processors to perform the computer-implemented method of any of Clauses 1-18.

What is claimed is:

1. A computer-implemented method for remotely modifying a configuration file defining a computing environment configuration, the computer-implemented method comprising, by one or more hardware processors executing program instructions:
receiving, from a remote server computing device, a configuration file defining a computing environment configuration;
parsing the configuration file to generate an indexed data structure, the indexed data structure comprising location identifiers of characters of the configuration file;
storing the indexed data structure;
generating a graphical user interface based at least in part on the indexed data structure;
receiving, via the graphical user interface, a user input indicating a modification to the computing environment configuration;
determining, by reference to the indexed data structure and the location identifiers, and based on the user input, one or more changes to the configuration file; and
communicating, to the remote server computing device, instructions to update the configuration file in accordance with the one or more changes.

2. The computer-implemented method of claim 1, wherein the indexed data structure comprises at least one of: a linear data structure, an array, a linked list, a stack, a queue, a tree, or a graph.

3. The computer-implemented method of claim 1, wherein the graphical user interface comprises one or more input selections, each input selection associated with at least a portion of the configuration file.

4. The computer-implemented method of claim 3, wherein the one or more input selections are generated based on the indexed data structure and parameters defining one or more options for the computing environment configuration.

5. The computer-implemented method of claim 4, wherein the computer-implemented method further comprises, by the one or more hardware processors executing program instructions:
receiving the parameters from the remote server computing device.

6. The computer-implemented method of claim 3, wherein the graphical user interface further comprises a textual display of the configuration file.

7. The computer-implemented method of claim 6, wherein the user input comprises at least one of a change to the textual display of the configuration file or a selection of an input selection of the one or more input selections.

8. The computer-implemented method of claim 1, wherein determining the one or more changes to the configuration file comprises:
determining, based on the user input, a portion of the configuration file associated with the modification to the computing environment configuration;
determining, from the indexed data structure, at least a first modification location identifier, of the location identifiers, associated with the portion of the configuration file, wherein the first modification location identifier indicates a location in the configuration file where the modification is to be implemented; and
determining at least a first change, of the one or more changes, to be made to characters of the configuration file as identified by the first modification location identifier.

9. The computer-implemented method of claim 1, wherein the one or more changes to the configuration file comprise a deletion of at least one character of the configuration file.

10. The computer-implemented method of claim 1, wherein the one or more changes to the configuration file comprise an addition of at least one character to the configuration file.

11. The computer-implemented method of claim 8, wherein the instructions to update the configuration file comprise:
one or more modification location identifiers, including at least the first modification location identifier, for each of the one or more changes; and
editing instructions configured to cause the remote server computing device to edit the configuration file based on the one or more changes and associated one or more modification location identifiers.

12. The computer-implemented method of claim 11, wherein the editing instructions comprise at least one of: an instruction to add at least one character or an instruction to delete at least one character.

13. The computer-implemented method of claim 11, wherein the remote server computing device is configured to:
receive the instructions to update the configuration file; and
for each of the one or more changes, execute the associated editing instructions to edit the configuration file in accordance with the editing instructions.

14. The computer-implemented method of claim 1, wherein the computer-implemented method further comprises, by the one or more hardware processors executing program instructions:
receiving, from the remote server computing device, an updated configuration file defining an updated computing environment configuration;
parsing the updated configuration file to generate an updated indexed data structure, the updated indexed data structure comprising location identifiers of each character of the updated configuration file; and
storing the updated indexed data structure.

15. The computer-implemented method of claim 1, wherein the computer-implemented method further comprises, by the one or more hardware processors executing program instructions:
generating a setup graphical user interface comprising one or more setup input selections, each setup input selection of the one or more setup input selections associated with a setup parameter for the computing environment configuration;
receiving, via the setup graphical user interface, a setup user input associated with each of the one or more setup input selections;
determining, based on the setup user input, initialization instructions for the configuration file; and
communicating, to the remote server computing device, the initialization instructions.

16. The computer-implemented method of claim 15, wherein the computer-implemented method further comprises, by the one or more hardware processors executing program instructions:
receiving, from the remote server computing device, setup parameters associated with each setup input selection of the one or more setup input selections.

17. The computer-implemented method of claim 15, wherein the initialization instructions are configured to cause the remote server computing device to generate the configuration file.

18. The computer-implemented method of claim 1, wherein the computer-implemented method further comprises, by the one or more hardware processors executing program instructions:
communicating, to a large language model (“LLM”), a prompt comprising at least: a user input, and one or more items of information associated with the computing environment configuration; and
receiving, from the LLM, an output indicative of at least one of:
the configuration file,
one or more changes to be made to the configuration file,
at least one setup input selection, or
at least one input selection.

19. A system comprising:
one or more computer-readable storage mediums having program instructions embodied therewith; and
one or more processors configured to execute the program instructions to cause the system to perform the computer-implemented method of claim 1.

20. A computer program product comprising one or more computer-readable storage medium having program instructions embodied therewith, the program instructions executable by one or more processors to cause the one or more processors to perform the computer-implemented method of any of claim 1.
